(19) United States
(12) Patent Application Publication
(10) Pub. No.: US 2025/0103190 A1
(43) Pub. Date: Mar. 27, 2025

(54) METHOD, APPARATUS, DEVICE AND STORAGE MEDIUM FOR INTERACTION

(71) Applicant: Beijing Youzhuju Network Technology Co., Ltd., Beijing (CN)

(72) Inventors: Qianqian ZHANG, Beijing (CN); Yuemeng Zhu, Beijing (CN)

(21) Appl. No.: 18/892,054

(22) Filed: Sep. 20, 2024

(30) Foreign Application Priority Data
Sep. 21, 2023 (CN) 202311228466.2

(51) Int. Cl. G06F 3/0484; G06F 3/0482; G06F 3/0483

(52) U.S. Cl. CPC G06F 3/0484; G06F 3/0482; G06F 3/0483

(57) ABSTRACT

Embodiments of the present disclosure provide a method, an apparatus, a device, and a storage medium for interaction. The method comprises: in response to a predetermined operation, presenting an object recommendation page, the object recommendation page comprising recommendation information respectively corresponding to a plurality of recommended objects, and the recommendation information comprising multimedia recommendation information of the recommended object; and in response to detecting a trigger operation for the multimedia recommendation information of a recommended object, presenting a multimedia content page corresponding to the recommended object, the multimedia content page being used for playing multimedia recommendation information corresponding to the recommended object. According to the technical solutions of embodiments of the present disclosure, in aid of providing multimedia recommendation information corresponding to a recommended object on a recommendation page, the distribution of the user's attention can be optimized, and the recommendation conversion rate can be improved.

### CROSS-REFERENCE

The present application claims priority to Chinese Patent Application No. 202311228466.2, filed on Sep. 21, 2023, and entitled “METHOD, APPARATUS, DEVICE AND STORAGE MEDIUM FOR INTERACTION”, the entirety of which is incorporated herein by reference.

### FIELD

Embodiments of the present disclosure relate to the field of computer technologies, and in particular, to a method, an apparatus, a device, and a storage medium for interaction.

### BACKGROUND

At present, when information is recommended, the content distribution in the recommendation page is usually unreasonable, or the recommended content is unattractive, which affects the click-through rate and conversion rate of users.

### SUMMARY

The present disclosure provides a method, an apparatus, a device, and a storage medium for interaction, so as to optimize distribution of the user's attention and improve recommendation conversion rate through providing multimedia recommendation information corresponding to recommended objects on a recommendation page.

According to a first aspect, an embodiment of the present disclosure provides an interaction method, including: in response to a predetermined operation, presenting an object recommendation page, the object recommendation page comprising recommendation information respectively corresponding to a plurality of recommended objects, and the recommendation information comprising multimedia recommendation information of the recommended object; and in response to detecting a trigger operation for the multimedia recommendation information of a recommended object, presenting a multimedia content page corresponding to the recommended object, the multimedia content page being used for playing multimedia recommendation information corresponding to the recommended object.

According to a second aspect, an embodiment of the present disclosure further provides an interaction apparatus, including: a presenting module, configured for, in response to a predetermined operation, presenting an object recommendation page, the object recommendation page comprising recommendation information respectively corresponding to a plurality of recommended objects, and the recommendation information comprising multimedia recommendation information of the recommended object; and a playing module, configured for, in response to detecting a trigger operation for the multimedia recommendation information of a recommended object, presenting a multimedia content page corresponding to the recommended object, the multimedia content page being used for playing multimedia recommendation information corresponding to the recommended object.

According to a third aspect, an embodiment of the present disclosure further provides an electronic device, including: one or more processors; and a storage device configured to store one or more programs. The one or more programs, when executed by the one or more processors, cause the one or more processors to implement the interaction method according to embodiments of the present disclosure.

According to a fourth aspect, an embodiment of the present disclosure further provides a storage medium comprising computer-executable instructions that, when executed by a computer processor, perform the interaction method according to embodiments of the present disclosure.

According to embodiments of the present disclosure, in response to a predetermined operation, an object recommendation page is presented, the object recommendation page comprising recommendation information respectively corresponding to a plurality of recommended objects, and the recommendation information comprising multimedia recommendation information of the recommended object; and in response to detecting a trigger operation for the multimedia recommendation information of a recommended object, a multimedia content page corresponding to the recommended object is presented, the multimedia content page being used for playing multimedia recommendation information corresponding to the recommended object. Thereby, the problem of low recommendation conversion rate in the related art is solved. In aid of providing multimedia recommendation information corresponding to a recommended object(s) on a recommendation page, the distribution of the user's attention can be optimized, and the recommendation conversion rate of product can be improved.

### BRIEF DESCRIPTION OF DRAWINGS

The above and other features, advantages, and aspects of various embodiments of the present disclosure will become more apparent from the following detailed description with reference to accompanying drawings. Throughout the drawings, the same or similar reference numbers refer to the same or similar elements. It should be understood that the drawings are schematic, and components and elements are not necessarily drawn to scale.

FIG. 1 is a schematic flowchart of an interaction method according to an embodiment of the present disclosure;

FIG. 2 is a schematic diagram of an object recommendation page according to an embodiment of the present disclosure;

FIG. 3 is a schematic diagram of a presentation mode switching entry of an object recommendation page according to an embodiment of the present disclosure;

FIG. 4 is a schematic diagram of playing a video associated with a recommended object according to an embodiment of the present disclosure;

FIG. 5 is a schematic flowchart of another interaction method according to an embodiment of the present disclosure;

FIG. 6 is a schematic diagram of combination styles for object set entry recommendation information according to an embodiment of the present disclosure;

FIG. 7 is a schematic diagram of an entry presentation page according to an embodiment of the present disclosure;

FIG. 8 is a schematic interaction diagram of function entry recommendation information according to an embodiment of the present disclosure;

FIG. 9 is a schematic structural diagram of an interaction apparatus according to an embodiment of the present disclosure;

FIG. 10 is a schematic structural diagram of an electronic device according to an embodiment of the present disclosure.

### DETAILED DESCRIPTION

Embodiments of the present disclosure will be described in more detail below with reference to the accompanying drawings. While certain embodiments of the present disclosure are shown in the drawings, it should be understood that the present disclosure may be implemented in various forms, and should not be construed as limited to the embodiments set forth herein. On the contrary, these embodiments are provided for a more thorough and complete understanding of the present disclosure. It should be understood that the drawings and embodiments of the present disclosure are for illustrative purposes only and are not intended to limit the scope of the present disclosure.

It should be understood that the steps recited in the method embodiments of the present disclosure may be performed in different orders, and/or in parallel. Further, the method embodiments may include additional steps and/or omit performing the illustrated steps. The scope of the present disclosure is not limited in this respect.

As used herein, the term “comprise” and variations thereof are open-ended, i.e., “comprising but not limited to”. The term “based on” means “based at least in part on”. The term “an embodiment” means “at least one embodiment”. The term “a further embodiment” means “at least one further embodiment”. The term “some embodiments” means “at least some embodiments”. The relevant definition of other terms will be given below.

It should be noted that concepts such as “first” and “second” mentioned in the present disclosure are merely used to distinguish different apparatuses, modules, or units, and are not intended to limit the order of functions performed by the apparatuses, modules, or units or the mutual dependency relationship.

It should be noted that the modification of “a” and “a plurality” mentioned in the present disclosure is illustrative and not limiting, and those skilled in the art should understand that both shall be interpreted as “one or more”, unless the context clearly indicates otherwise.

The names of messages or information interacted between multiple apparatuses in embodiments of the present disclosure are for illustrative purposes only and are not intended to limit the scope of such messages or information.

It should be understood that, before the technical solutions disclosed in the embodiments of the present disclosure are used, the types of personal information related to the present disclosure, the usage scope, the usage scenario and the like should be notified to the user in an appropriate manner according to the relevant laws and regulations and obtain the authorization of the user.

For example, in response to receiving a voluntary request from a user, prompt information is sent to the user to explicitly prompt the user that the requested operation will need to acquire and use the personal information of the user. Therefore, the user can autonomously select whether to provide personal information to software or hardware executing the operation of the technical solution of the present disclosure according to the prompt information.

As an optional but non-limiting implementation, in response to receiving the voluntary request of the user, the manner of sending the prompt information to the user may be, for example, a pop-up window, and the prompt information may be presented in a text manner in the pop-up window. In addition, the pop-up window may further carry a selection control for the user to select “agree” or “disagree” to provide personal information to the electronic device.

It should be understood that the foregoing processes of notification and obtaining a user's authorization is merely illustrative, and do not constitute a limitation on implementations of the present disclosure, and other manners for meeting related laws and regulations may also be applied to implementations of the present disclosure.

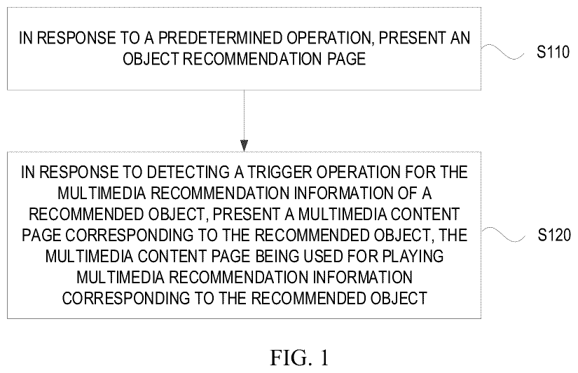

FIG. 1 is a schematic flowchart of an interaction method according to an embodiment of the present disclosure. Embodiments of the present disclosure are applicable to a scenario of recommending a product(s) to a user(s) through a recommendation page. The method may be executed by an interaction apparatus, which may be implemented in the form of software and/or hardware. Alternatively, it may be implemented through an electronic device. The electronic device may be a mobile terminal, PC, server, or the like. As shown in FIG. 1, the method includes:

S110, in response to a predetermined operation, presenting an object recommendation page.

The object recommendation page comprises recommendation information respectively corresponding to a plurality of recommended objects. The recommendation information comprises multimedia recommendation information of the recommended object. The recommendation information of the recommended object refers to information that is associated with the recommended object and used to describe the recommended object. The recommendation information includes attribute information and multimedia recommendation information of the recommended object, and an entry control of an operation corresponding to the recommended object. The recommendation information may be presented in a form of a card, or may be displayed in other forms, which are not specifically limited in this embodiment. The attribute information refers to feature information of the recommended object itself, including information such as a picture, a price, and a sales volume of the recommended object. The multimedia recommendation information refers to comprehensive information in a plurality of media forms that is associated with the recommended object, and the multimedia recommendation information includes a video associated with the recommended object.

The recommendation information comprises an attribute region, an operation control region and a multimedia information region. The attribute region is used for presenting attribute information of the recommended object. The operation control region is used for presenting an entry control of an operation corresponding to the recommended object. The multimedia information region is used for presenting the multimedia recommendation information.

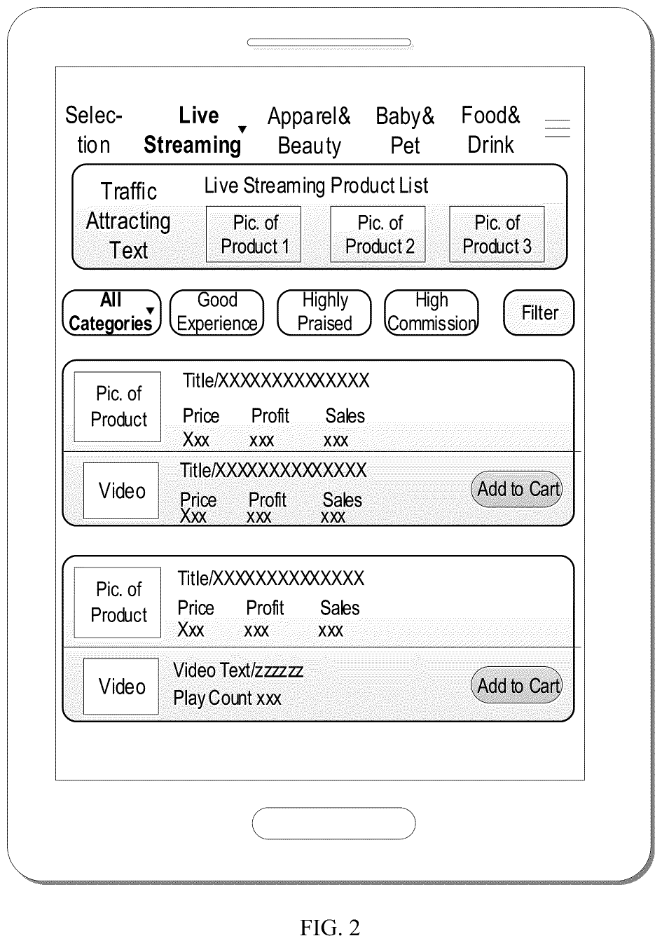

For example, the object recommendation page shown in FIG. 2 includes recommendation information in the form of cards respectively corresponding to different products. Data associated with a product (such as a picture, a price, a profit, a sales of the product or the like) included in the recommendation information belong to the attribute information of the product, and a region presenting the product attribute information is the attribute region. The product content page may be presented in response to a trigger operation on the attribute region. A recommendation video and data related to the video (such as video text, video play count, and the like) included in the recommendation information belong to multimedia recommendation information, and a region presenting the multimedia recommendation information is the multimedia information region. In response to a sliding operation for the object recommendation page, if it is detected that the multimedia recommendation information region falls within a specified region of the screen, the recommendation video of the product is played in the multimedia recommendation information region. The operation entry control included in the recommendation information may be an entry control corresponding to an operation of adding a product into shopping cart, or may be an entry control corresponding to a further operation, and a region in which the operation entry control is located is an operation control region.

In an optional implementation, the method further includes: presenting an object recommendation page comprising a presentation mode switching entry, wherein the presentation mode switching entry displays an identifier of a presentation mode corresponding to a currently displayed object recommendation page; in response to a trigger operation for the presentation mode switching entry, presenting identifiers of a plurality of presentation modes; and in response to a selection operation for an identifier of a target presentation mode from the identifiers of the plurality of presentation modes, presenting the object recommendation page corresponding to the target presentation mode.

The presentation mode refers to information representing a source of recommendation information of the recommended object. The presentation mode includes a multimedia presentation mode and a non-multimedia presentation mode. The multimedia presentation mode includes a live streaming mode or a short-form video mode, and the non-multimedia presentation mode includes a show window mode and an image-text mode. The presentation mode switching entry refers to a control used for switching the presentation mode. The presentation mode switching entry displays an identifier of a presentation mode, and it displays the identifiers of a plurality of presentation modes after being triggered.

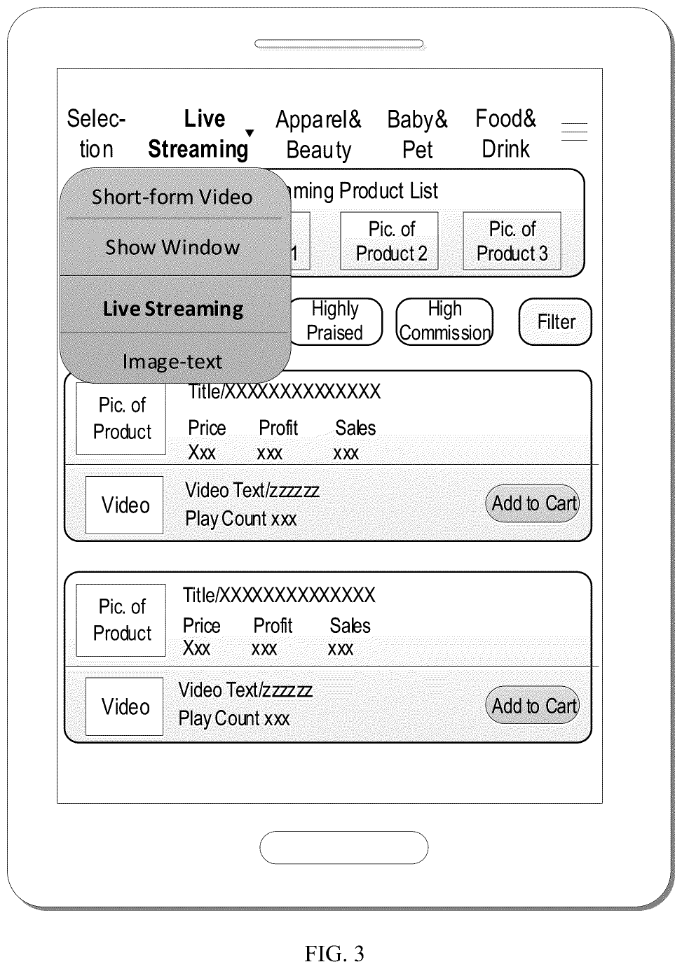

For example, with reference to the object recommendation page in the live streaming mode shown in FIG. 2, the presentation mode switching entry at the top of the object recommendation page displays an identifier of the live streaming mode. When a trigger operation for the presentation mode switching entry is detected, identifiers of a plurality of presentation modes (e.g., an identifier of the short-form video mode, an identifier of the show window mode, an identifier of the live streaming mode, and an identifier of the image-text mode) may be displayed below the presentation mode switching entry as shown in FIG. 3. When a selection operation for an identifier of a target presentation mode from the identifiers of the plurality of presentation modes is detected (for example, a click operation on the identifier of the short-form video mode is detected), the object recommendation page corresponding to the short-form video mode is displayed.

In an optional implementation, the object recommendation page further includes information to be recommended. Regions where the information to be recommended and recommendation information of the recommended object are located are independent from each other, and data sources of the information to be recommended and recommendation information of the recommended object are independent from each other.

In this embodiment, the object recommendation page may further include information to be recommended corresponding to the current presentation mode, and the information to be recommended refers to information that is associated with a specified recommended object and used to describe the specified recommended object, for example, the product list recommendation information corresponding to the live streaming mode in FIG. 2. As shown in FIG. 2, the product list recommendation information may be displayed in a banner form. The product list recommendation information includes a traffic attracting text corresponding to the live streaming mode, and pictures of products with top 3 sales volume among the product list corresponding to the live streaming mode. The region where the product list recommendation information is located and the region where the product recommendation information is located are independent from each other, and the data source of the product list recommendation information and the data source of the product recommendation information are independent from each other. If a trigger operation for the product list recommendation information is detected, a list content page of the live streaming mode corresponding to the product list recommendation information may be displayed.

S120: in response to detecting a trigger operation for the multimedia recommendation information of a recommended object, present a multimedia content page corresponding to the recommended object, the multimedia content page being used for playing multimedia recommendation information corresponding to the recommended object.

The multimedia recommendation information of the recommended object includes a video associated with the recommended object. For the same recommended object, different presentation modes correspond to different videos associated with the recommended object. For example, for the recommended object A, the video associated with the recommended object corresponding to the live streaming mode is a live streaming video related to the recommended object A, and the video associated with the recommended object corresponding to the short-form video mode is a short-form video related to the recommended object A.

In an optional implementation, in response to detecting the trigger operation for the multimedia recommendation information of the recommended object, presenting a multimedia content page corresponding to the recommended object, and playing, in the multimedia content page, the video associated with the recommended object that is from the corresponding presentation mode.

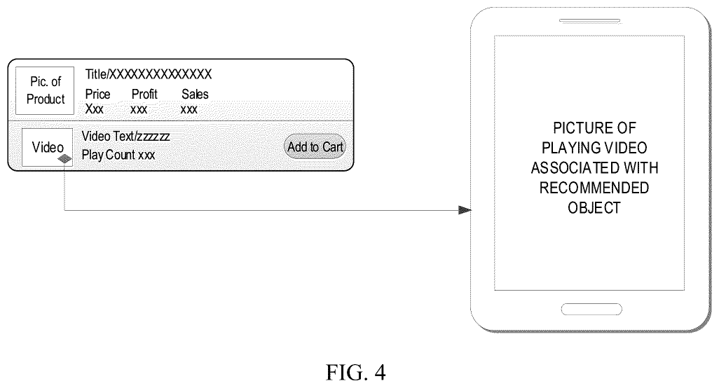

For example, as shown in FIG. 4, in response to a click operation on the multimedia recommendation information of the recommended object, the multimedia content page corresponding to the recommended object is presented. If the corresponding presentation mode is the live streaming mode, a live streaming video associated with the recommended object is played in the multimedia content page. If the corresponding presentation mode is the short-form video mode, a short-form video associated with the recommended object is played in the multimedia content page.

According to the technical solutions of the embodiment of the present disclosure, in response to a predetermined operation, an object recommendation page is presented, the object recommendation page comprising recommendation information respectively corresponding to a plurality of recommended objects, and the recommendation information comprising multimedia recommendation information of the recommended object; and in response to detecting a trigger operation for the multimedia recommendation information of a recommended object, a multimedia content page corresponding to the recommended object is presented, the multimedia content page being used for playing multimedia recommendation information corresponding to the recommended object. Thereby, the problem of low recommendation conversion rate in the related art is solved. In aid of providing multimedia recommendation information corresponding to recommended objects in a recommendation page, the distribution of the user's attention can be optimized, and the recommendation conversion rate of product can be improved.

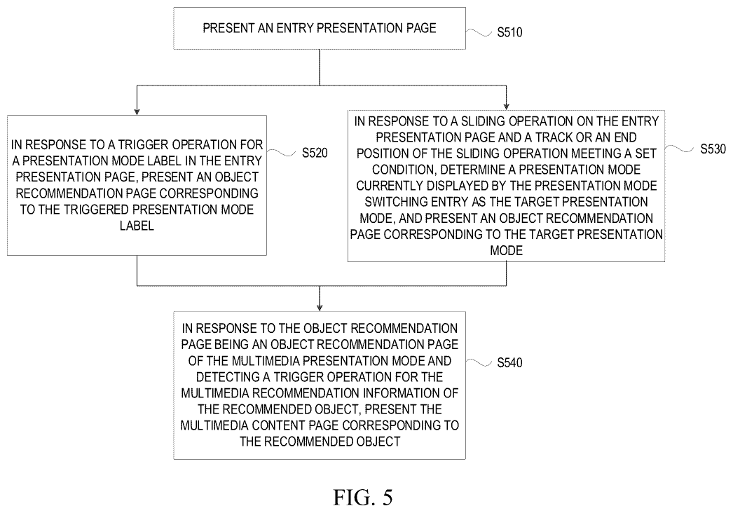

FIG. 5 is a schematic flowchart of another interaction method according to an embodiment of the present disclosure. On the basis of the above embodiments, this embodiment further provides a step of entering the object presentation page based on an entry presentation page, as well as interactive operations corresponding to various recommended information included in the entry presentation page. As shown in FIG. 5, the method includes:

S510: present an entry presentation page.

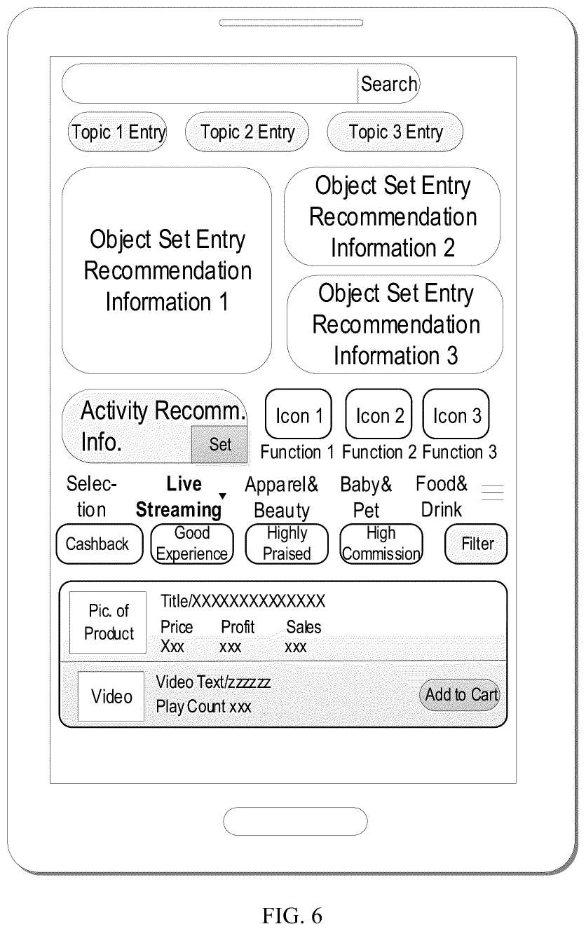

The entry presentation page refers to a page presenting a plurality of different entry recommendation information. The entry presentation page includes a presentation mode switching entry. For example, as shown in FIG. 6, the entry presentation page includes different entry recommendation information, such as topic entries, object set entries, activity entries, function entries, and a presentation mode switching entry. When the plurality of entry recommendation information are triggered respectively, a corresponding content page may be presented. The presentation mode includes a multimedia presentation mode and a non-multimedia presentation mode. The multimedia presentation mode includes a live streaming mode or a short-form video mode, and the non-multimedia presentation mode includes a show window mode and an image-text mode.

S520: in response to a trigger operation for a presentation mode label in the entry presentation page, present an object recommendation page corresponding to the triggered presentation mode label.

In this embodiment, the presentation mode label refers to information for filtering and classifying recommendation information of the recommended object based on the data source, and includes a live streaming mode label, a short-form video mode label, a show window mode label, and an image-text mode label. A plurality of presentation mode labels may be presented in the entry presentation page, for example, three presentation mode labels are sequentially displayed in a specified region in the entry presentation page. When a trigger operation for one of the presentation mode labels is detected, an object recommendation page corresponding to the triggered presentation mode label is presented.

The presentation order of the plurality of presentation mode labels may be determined based on predetermined presentation mode priorities and attention weights of the user for the presentation modes. A presentation mode priority refers to a parameter used to indicate an importance of a presentation mode, and a smaller priority value corresponds to a higher importance. For example, the priority of the live streaming mode is 1, the priority of the short-form video mode is 2, the priority of the show window mode is 3, the priority of the image-text mode is 4, and the importance decreases sequentially. An attention weight is a parameter used to describe a liking degree of the current user for each presentation mode, and the greater an attention weight of a presentation mode, the higher the liking degree of the user for this presentation mode. For example, the attention weight of the live streaming mode is 4, the attention weight of the short-form video mode is 3, the attention weight of the show window mode is 2, the attention weight of the image-text mode is 1, and the user liking degree decreases sequentially. A first type of presentation modes with user attention weight value are sorted in descending order of user attention weight values. A second type of presentation modes without user attention weight value are sorted in ascending order of presentation mode priority values. The sorted second type of presentation modes are placed to the end of the sorted first type of presentation mode to obtain the presentation order of the plurality of presentation mode labels.

S530: in response to a sliding operation on the entry presentation page and a track or an end position of the sliding operation meeting a set condition, determine a presentation mode currently displayed by the presentation mode switching entry as the target presentation mode, and present an object recommendation page corresponding to the target presentation mode.

In this embodiment, in response to the sliding operation on the entry presentation page, if the start position of the track of the sliding operation corresponds to the presentation mode switching entry of the entry presentation page, the end position of the track corresponds to a specified position in the screen, or the end position of the sliding operation falls within a predetermined region of the screen for a predetermined duration, the ceiling state is entered, the presentation mode currently displayed by the presentation mode switching entry is determined as the target presentation mode, and the object recommendation page corresponding to the target presentation mode is presented. This embodiment does not limit the set condition that should be met by the track or the end position of the sliding operation, and the set condition may be correspondingly adjusted according to the requirement.

In an optional implementation, the presentation mode switching entry displays an identifier of a presentation mode corresponding to a currently presented object recommendation page. In response to a trigger operation for an identifier of the presentation mode currently displayed by the presentation mode switching entry, identifiers of a plurality of presentation modes are displayed. A presentation order of the identifiers of the plurality of presentation modes is determined based on predetermined priorities.

In this embodiment, as shown in FIG. 6, the identifier of the live streaming mode is displayed in the presentation mode switching entry in the entry presentation page. In response to a sliding operation for the entry presentation page, when the track or the end position of the sliding operation meets the set condition, the object recommendation page corresponding to the live streaming mode is displayed. When a trigger operation for the identifier of the live streaming mode currently displayed by the presentation mode switching access is detected, the identifiers of the plurality of presentation modes may be displayed in an order of the predetermined priorities as shown in FIG. 3. For example, the identifier of the short-form video mode, the identifier of the show window mode, the identifier of the live streaming mode, and the identifier of the image-text mode are displayed in sequence.

S540: in response to the object recommendation page being an object recommendation page of the multimedia presentation mode and detecting a trigger operation for the multimedia recommendation information of the recommended object, present the multimedia content page corresponding to the recommended object.

In this embodiment, the object recommendation page of the multimedia presentation mode includes the multimedia recommendation information of the recommended object, and the object recommendation page of the non-multimedia presentation mode does not include the multimedia recommendation information of the recommended object. After determining that the presented object recommendation page is the object recommendation page of the multimedia presentation mode, if a trigger operation for the multimedia recommendation information of the recommended object is detected (for example, a trigger operation for a video associated with the recommended object is detected), the multimedia content page corresponding to the recommended object is presented, and a video associated with the recommended object from the corresponding presentation mode is played in the multimedia content page to facilitate conversion. The multimedia recommendation information is added to the recommendation information corresponding to respective recommended objects in the object recommendation page, so that the content richness of the recommendation page can be improved, and more user demand scene can be satisfied.

In an optional implementation, the method further includes: presenting an entry presentation page in which a predetermined amount of object set entry recommendation information matching a current user type is presented, wherein the object set entry recommendation information is presented based on a target combination style corresponding to the current user type, and the target combination style is used to indicate a page presentation position and a size corresponding to each piece of the object set entry recommendation information; and in response to a trigger operation for object set entry recommendation information in the entry presentation page, presenting an object recommendation page of the triggered object set entry recommendation information.

In this embodiment, in order to optimize user attention distribution, the object set entry recommendation information may be placed at the top of the entry presentation page for presentation, so as to enhance the user's perception of the object set entry recommendation information in the entry presentation page. The users may also be classified, different user types correspond to different amounts of object set entry recommendation information, and different combination styles of object set entry recommendation information, so as to further attract user's attention. The user type may include a new user, a primary old user, a secondary old user, and the like.

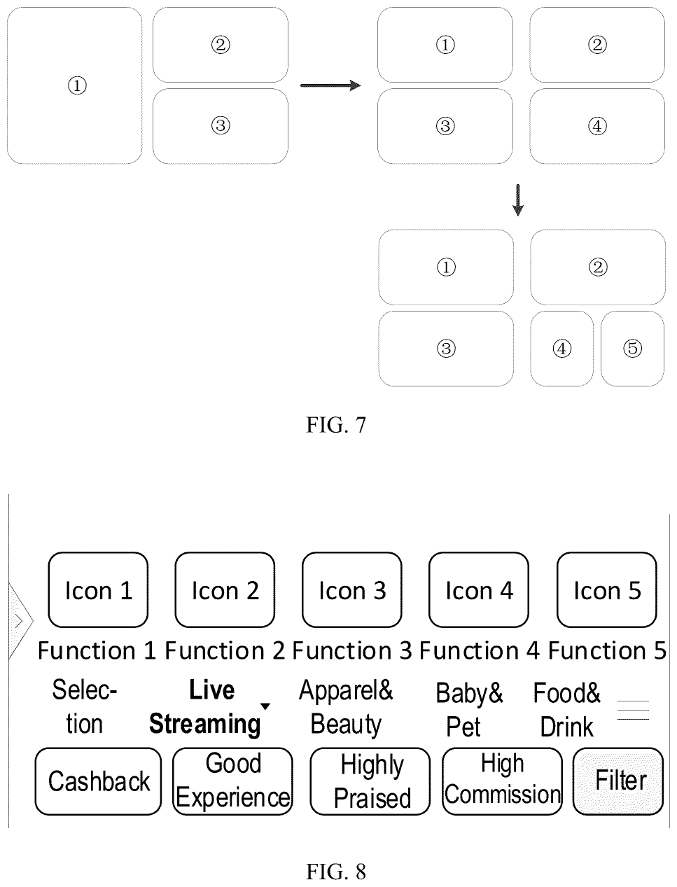

The object set entry recommendation information refers to information that is associated with a set of recommended objects and used to describe the set of recommended objects. The object set entry recommendation information may include information such as a title, a traffic attracting text, a picture of a hot-selling product, as well as a price and a profit related to the product. A combination style of the object set entry recommendation information is used to indicate a page presentation position and a size corresponding to each piece of the object set entry recommendation information. For example, a combination style corresponding to different amounts of object set entry recommendation information may be shown in FIG. 7.

By way of example, if the current user type corresponds to three pieces of object set entry recommendation information, and the combination style of the object set entry recommendation information corresponding to the current user type is a combination style of one on the left and two on the right as shown in FIG. 7, three pieces of object set entry recommendation information corresponding to the current user type may be presented in the entry presentation page, as shown in FIG. 6. If a trigger operation for the object set entry recommendation information in the entry presentation page is detected, the object recommendation page of the triggered object set entry recommendation information is presented.

In an optional implementation, the method further includes: presenting an entry presentation page in which activity recommendation information is presented, the activity recommendation information comprising at least one activity entry and an activity set entry; in response to a trigger operation for the activity set entry, presenting an activity set content page corresponding to the activity set entry; in response to a trigger operation for the activity entry, presenting a target activity content page corresponding to the triggered activity entry.

In this embodiment, the entry presentation page may further present activity recommendation information. The activity recommendation information refers to information that is related to a specified activity and used to describe the specified activity, and it includes an entry for recommended activity, a traffic attracting text, and the like. The activity recommendation information includes at least one activity entry and an activity set entry. An activity entry refers to a control used for entering an activity content page corresponding to an activity, and an activity set entry refers to a control used for entering an activity set content page including several activity entries. By combining the at least one activity entry with the activity set entry, the entry form for a set of activities is changed and the entry cost is reduced.

By way of example, as shown in FIG. 6, at least one activity entry is automatically switched to be displayed in the activity recommendation information of the entry presentation page. In response to a trigger operation for an activity entry, the activity entry currently presented in the activity recommendation information is determined, and the target activity content page corresponding to this activity entry is presented. As shown in FIG. 6, an activity set entry is arranged at a lower right corner of the activity recommendation information, and in response to a trigger operation for an activity set entry, an activity set content page corresponding to the activity set entry is presented. The activity set content page corresponding to the activity set entry may include a plurality of activity entries, and at least one activity entry included in the activity recommendation information may be included in the activity set content page.

In an optional implementation, the method further includes: in response to a first trigger operation on a region where first recommendation information is located, hiding the first recommendation information, and presenting set function entry recommendation information; and in response to a second trigger operation on a region where the set function entry recommendation information is located, hiding the set function entry recommendation information, and presenting the first recommendation information.

The first trigger operation is a sliding operation along a first direction on a region where the first recommendation information is located, the second trigger operation is a sliding operation along a second direction on a region where the set function entry recommendation information is located, and the first direction is opposite to the second direction; or a set control is displayed in the region where the first recommendation information is located or the region where the set function entry recommendation information is located, and the first trigger operation or the second trigger operation is a trigger operation for the set control.

The first recommendation information may be any type of recommendation information, such as activity recommendation information, product recommendation information, product list recommendation information, etc., in the entry presentation page. The function entry recommendation information refers to information that is associated with a corresponding function and used to describe the function. The function entry recommendation information includes an icon and a function name of a corresponding function. By setting an interaction action between the function entry recommendation information and the first recommendation information, the user's attention can be attracted, and different recommendation information may be presented based on the user's hierarchical different requirements.

For example, taking the first recommendation information being the activity recommendation information as an example, the entry presentation page is shown in FIG. 6, and three piece of function entry recommendation information are presented in the entry presentation page. In response to a sliding operation along a first direction on a region in which the activity recommendation information is located (for example, a leftward sliding operation), the activity recommendation information is hidden, and a predetermined function entry recommendation information is presented, as shown in FIG. 8. In response to a sliding operation along the second direction on the region where the set function entry recommendation information is located (for example, a rightward sliding operation), the set function entry recommendation information is hidden, and the activity recommendation information is presented.

After hiding the activity recommendation information and presenting the set function entry recommendation information in response to a sliding operation along a first direction on the region where the activity recommendation information is located, a set control may be displayed in the region where the activity recommendation information is located. If a set control is displayed in a region in the entry presentation page where the activity recommendation information is located, in the region where the activity recommendation information is located, the set function entry recommendation information is hidden in response to a trigger operation for the set control, and the activity recommendation information is presented.

After hiding the set function entry recommendation information, and presenting the first recommendation information in response to a sliding operation along a second direction on a region where the set function entry recommendation information is located, the set control may be displayed in the region where the set function entry recommendation information is located. If a set control is displayed in a region in the entry presentation page where the set function entry recommendation information is located, in response to a trigger operation for the set control in the region where the set function entry recommendation information is located, the activity recommendation information is hidden, and the set function entry recommendation information is presented.

According to the technical solutions of the embodiments of the present disclosure, in response to a predetermined operation, an object recommendation page is presented, the object recommendation page comprising recommendation information respectively corresponding to a plurality of recommended objects, and the recommendation information comprising multimedia recommendation information of the recommended object; and in response to detecting a trigger operation for the multimedia recommendation information of a recommended object, a multimedia content page corresponding to the recommended object is presented, the multimedia content page being used for playing multimedia recommendation information corresponding to the recommended object. Thereby, the problem of low recommendation conversion rate in the related art is solved. In aid of providing multimedia recommendation information corresponding to recommended objects on a recommendation page, the distribution of the user's attention can be optimized, and the recommendation conversion rate of product can be improved.

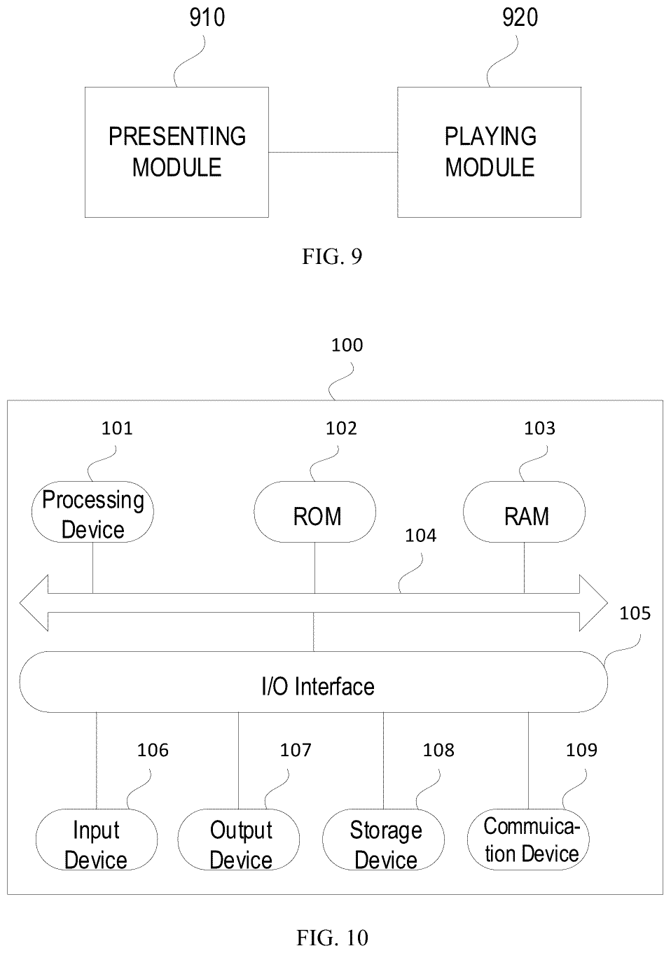

FIG. 9 is a schematic structural diagram of an interaction apparatus according to an embodiment of the present disclosure. As shown in FIG. 9, the apparatus comprises a presenting module 910 and a playing module 920. The presenting module 910 is configured for, in response to a predetermined operation, presenting an object recommendation page, the object recommendation page comprising recommendation information respectively corresponding to a plurality of recommended objects, and the recommendation information comprising multimedia recommendation information of the recommended object. The playing module 920 is configured for, in response to detecting a trigger operation for the multimedia recommendation information of a recommended object, presenting a multimedia content page corresponding to the recommended object, the multimedia content page being used for playing multimedia recommendation information corresponding to the recommended object.

According to the technical solutions of the embodiments of the present disclosure, in response to a predetermined operation, an object recommendation page is presented, the object recommendation page comprising recommendation information respectively corresponding to a plurality of recommended objects, and the recommendation information comprising multimedia recommendation information of the recommended object; and in response to detecting a trigger operation for the multimedia recommendation information of a recommended object, a multimedia content page corresponding to the recommended object is presented, the multimedia content page being used for playing multimedia recommendation information corresponding to the recommended object. Thereby, the problem of low recommendation conversion rate in the related art is solved. In aid of providing multimedia recommendation information corresponding to recommended objects on a recommendation page, the distribution of the user's attention can be optimized, and the recommendation conversion rate of product can be improved.

Optionally, the presentation mode includes a multimedia presentation mode and a non-multimedia presentation mode, and the multimedia presentation mode includes a live streaming mode or a short-form video mode.

The recommendation information comprises an attribute region, an operation control region and a multimedia information region, the attribute region is used for presenting attribute information of the recommended object, the operation control region is used for presenting an entry control of an operation corresponding to the recommended object, and the multimedia information region is used for presenting the multimedia recommendation information.

Optionally, the apparatus further includes a first presenting module configured for: presenting an entry presentation page comprising a presentation mode switching entry; and in response to a trigger operation for a presentation mode label in the entry presentation page, presenting an object recommendation page corresponding to the triggered presentation mode label; or in response to a sliding operation on the entry presentation page and a track or an end position of the sliding operation meeting a set condition, determining a presentation mode currently displayed by the presentation mode switching entry as the target presentation mode, and presenting an object recommendation page corresponding to the target presentation mode.

Optionally, the presentation mode switching entry displays an identifier of a presentation mode corresponding to a currently presented object recommendation page. The apparatus further includes: a presentation mode triggering module configured for: in response to a trigger operation for an identifier of the presentation mode currently displayed by the presentation mode switching entry, displaying identifiers of a plurality of presentation modes, wherein a presentation order of the identifiers of the plurality of presentation modes is determined based on predetermined priorities.

Optionally, the apparatus further includes a second presenting module configured for: resenting an object recommendation page comprising a presentation mode switching entry, the presentation mode switching entry displaying an identifier of a presentation mode corresponding to a currently displayed object recommendation page; in response to a trigger operation for the presentation mode switching entry, presenting identifiers of a plurality of presentation modes; in response to a selection operation for an identifier of a target presentation mode from the identifiers of the plurality of presentation modes, presenting the object recommendation page corresponding to the target presentation mode.

Optionally, the playing module 920 is configured for: in response to detecting the trigger operation for the multimedia recommendation information of the recommended object, presenting a multimedia content page corresponding to the recommended object, and playing, in the multimedia content page, a video associated with the recommended object that is from the corresponding presentation mode.

Optionally, the object recommendation page further comprises information to be recommended. A region where the information to be recommended is located and a region where recommendation information of the recommended object is located are independent from each other, and a data source of the information to be recommended and a data source of recommendation information of the recommended object are independent from each other.

Optionally, the apparatus further includes a first triggering module configured for: presenting an entry presentation page in which a predetermined amount of object set entry recommendation information matching a current user type is presented, wherein the object set entry recommendation information is presented based on a target combination style corresponding to the current user type, and the target combination style is used to indicate a page presentation position and a size corresponding to each piece of the object set entry recommendation information; and in response to a trigger operation for object set entry recommendation information in the entry presentation page, presenting an object recommendation page of the triggered object set entry recommendation information.

Optionally, the apparatus further includes a second triggering module configured for: presenting an entry presentation page in which activity recommendation information is presented, the activity recommendation information comprising at least one activity entry and an activity set entry; in response to a trigger operation for the activity set entry, presenting an activity set content page corresponding to the activity set entry; in response to a trigger operation for the activity entry, presenting a target activity content page corresponding to the triggered activity entry.

Optionally, the apparatus further includes a third triggering module configured for: in response to a first trigger operation on a region where first recommendation information is located, hiding the first recommendation information, and presenting set function entry recommendation information; in response to a second trigger operation on a region where the set function entry recommendation information is located, hiding the set function entry recommendation information, and presenting the first recommendation information; wherein the first trigger operation is a sliding operation along a first direction on a region where the first recommendation information is located, the second trigger operation is a sliding operation along a second direction on a region where the set function entry recommendation information is located, and the first direction is opposite to the second direction; or a set control is displayed in the region where the first recommendation information is located or the region where the set function entry recommendation information is located, and the first trigger operation or the second trigger operation is a trigger operation for the set control.

The interaction apparatus provided in the embodiments of the present disclosure may perform the interaction method provided by any embodiment of the present disclosure, and has functional modules and beneficial effects corresponding to executing the method.

It should be noted that the units and modules included in the foregoing apparatus are only divided according to the function logic, but are not limited to the foregoing division, as long as the corresponding functions may be implemented. In addition, the specific names of the functional units are merely for ease of distinguishing, and are not intended to limit the protection scope of the embodiments of the present disclosure.

FIG. 10 is a schematic structural diagram of an electronic device according to an embodiment of the present disclosure. Reference is made to FIG. 10, which illustrates a schematic structural diagram of an electronic device (such as the terminal device or server in FIG. 10) 100 suitable for implementing the embodiments of the present disclosure. The terminal device in the embodiments of the present disclosure may include, but is not limited to, a mobile terminal such as a mobile phone, a laptop computer, a digital broadcast receiver, a PDA (personal digital assistant), a PAD (portable android device), a PMP (portable multimedia player), an in-vehicle terminal (for example, an in-vehicle navigation terminal), and a fixed terminal such as a digital TV, a desktop computer, or the like. The electronic device shown in FIG. 10 is merely an example, and should not impose any limitation on the functions and scope of use of the embodiments of the present disclosure.

As shown in FIG. 10, the electronic device 100 may include a processing device (for example, a central processing unit, a graphics processor, etc.) 101, which may perform various appropriate actions and processing according to a program stored in a read-only memory (ROM) 102 or a program loaded into a random access memory (RAM) 103 from a storage device 108. In the RAM 103, various programs and data required for the operation of the electronic device 100 are also stored. The processing device 101, the ROM 102, and the RAM 103 are connected to each other through a bus 104. An input/output (I/O) interface 105 is also connected to the bus 104.

Generally, the following devices may be connected to the I/O interface 105: an input device 106 including, for example, a touch screen, a touchpad, a keyboard, a mouse, a camera, a microphone, an accelerometer, a gyroscope, etc.; an output device 107 including, for example, a liquid crystal display (LCD), a speaker, a vibrator, etc.; a storage device 108 including, for example, a magnetic tape, a hard disk, etc.; and a communication device 109. The communication device 109 may allow the electronic device 100 to communicate wirelessly or wired with other devices to exchange data. While FIG. 10 shows an electronic device 100 having various devices, it should be understood that it is not required to implement or have all illustrated devices. More or fewer devices may alternatively be implemented or provided.

In particular, according to an embodiment of the present disclosure, the process described above with reference to the flowchart may be implemented as a computer software program. For example, embodiments of the present disclosure include a computer program product comprising a computer program carried on a non-transitory computer readable medium, the computer program comprising program code for performing the method shown in the flowchart. In such embodiments, the computer program may be downloaded and installed from the network through the communication device 109, or installed from the storage device 108, or from the ROM 102. When the computer program is executed by the processing apparatus 101, the foregoing functions defined in the method of the embodiments of the present disclosure are performed.

The names of messages or information interacted between multiple devices in embodiments of the present disclosure are for illustrative purposes only and are not intended to limit the scope of such messages or information.

The electronic device provided by the embodiments of the present disclosure and the interaction method provided in the foregoing embodiments belong to the same inventive concept, technical details not described in detail in this embodiment may refer to the foregoing embodiments, and this embodiment has the same beneficial effects as the foregoing embodiments.

An embodiment of the present disclosure provides a computer storage medium having a computer program stored thereon. The program, when executed by a processor, implements the interaction method provided in the foregoing embodiments.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, including but not limited to: wires, optical cables, RF (radio frequency), and the like, or any suitable combination of the foregoing.

In some implementations, the client and server may communicate using any currently known or future developed network protocol, such as HTTP (HyperText Transfer Protocol), and may be interconnected with any form or medium of digital data communication (e.g., a communication network). Examples of communication networks include local area networks (“LANs”), wide area networks (“WANs”), internets (e.g., the Internet), and peer-to-peer networks (e.g., ad hoc peer-to-peer networks), as well as any currently known or future developed networks.

The computer-readable medium described above may be included in the electronic device; or may be separately present without being assembled into the electronic device.

The computer readable medium carries one or more programs. The one or more programs, when executed by the electronic device, cause the electronic device to: in response to a predetermined operation, present an object recommendation page, the object recommendation page comprising recommendation information respectively corresponding to a plurality of recommended objects, and the recommendation information comprising multimedia recommendation information of the recommended object; and in response to detecting a trigger operation for the multimedia recommendation information of a recommended object, present a multimedia content page corresponding to the recommended object, the multimedia content page being used for playing multimedia recommendation information corresponding to the recommended object.

Computer program code for performing the operations of the present disclosure may be written in one or more programming languages, including, but not limited to, object oriented programming languages, such as Java, Smalltalk, C++, and conventional procedural programming languages, such as C language or similar programming languages. The program code may execute entirely on a user computer, partially on a user computer, as a stand-alone software package, partially on a user computer and partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in an order different from that illustrated in the figures. For example, two consecutively represented blocks may actually be performed substantially in parallel, and sometimes they may be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. The name of a unit does not constitute a limitation on the unit itself under certain circumstances. For example, the first obtaining unit may be further described as “a unit for obtaining at least two Internet Protocol addresses”.

The functions described above may be performed, at least in part, by one or more hardware logic components. By way of example rather than limitation, example types of hardware logic components that may be used include: field programmable gate array (FPGA), application specific integrated circuit (ASIC), application specific standard product (ASSP), system-on-a-chip (SOC), complex programmable logic device (CPLD), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

The above description is merely an illustration of the preferred embodiments of the present disclosure and the principles of the application. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept, for example, a technical solution formed by replacing technical features disclosed in the present disclosure (but not limited to them) with the above features.

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. On the contrary, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely example forms of implementing the claims.

I/We claim:

1. An interaction method, comprising:
in response to a predetermined operation, presenting an object recommendation page, the object recommendation page comprising recommendation information respectively corresponding to a plurality of recommended objects, and the recommendation information comprising multimedia recommendation information of the recommended object; and
in response to detecting a trigger operation for the multimedia recommendation information of a recommended object, presenting a multimedia content page corresponding to the recommended object, the multimedia content page being used for playing multimedia recommendation information corresponding to the recommended object.

2. The method of claim 1, wherein the recommendation information comprises an attribute region, an operation control region and a multimedia information region, the attribute region is used for presenting attribute information of the recommended object, the operation control region is used for presenting an entry control of an operation corresponding to the recommended object, and the multimedia information region is used for presenting the multimedia recommendation information.

3. The method of claim 2, further comprising:
presenting an entry presentation page comprising a presentation mode switching entry; and
in response to a trigger operation for a presentation mode label in the entry presentation page, presenting an object recommendation page corresponding to the triggered presentation mode label; or
in response to a sliding operation on the entry presentation page and a track or an end position of the sliding operation meeting a set condition, determining a presentation mode currently displayed by the presentation mode switching entry as the target presentation mode, and presenting an object recommendation page corresponding to the target presentation mode.

4. The method of claim 3, wherein the presentation mode switching entry displays an identifier of a presentation mode corresponding to a currently presented object recommendation page, and the method further comprises:
in response to a trigger operation for an identifier of the presentation mode currently displayed by the presentation mode switching entry, displaying identifiers of a plurality of presentation modes,
wherein a presentation order of the identifiers of the plurality of presentation modes is determined based on predetermined priorities.

5. The method of claim 2, further comprising:
presenting an object recommendation page comprising a presentation mode switching entry, the presentation mode switching entry displaying an identifier of a presentation mode corresponding to a currently displayed object recommendation page;
in response to a trigger operation for the presentation mode switching entry, presenting identifiers of a plurality of presentation modes;
in response to a selection operation for an identifier of a target presentation mode from the identifiers of the plurality of presentation modes, presenting the object recommendation page corresponding to the target presentation mode.

6. The method of claim 2, wherein in response to detecting the trigger operation for the multimedia recommendation information of the recommended object, presenting a multimedia content page corresponding to the recommended object comprises:
in response to detecting the trigger operation for the multimedia recommendation information of the recommended object, presenting a multimedia content page corresponding to the recommended object, and playing, in the multimedia content page, a video associated with the recommended object that is from the corresponding presentation mode.

7. The method of claim 1, wherein the object recommendation page further comprises information to be recommended, regions where the information to be recommended and recommendation information of the recommended object are located are independent from each other, and data sources of the information to be recommended and recommendation information of the recommended object are independent from each other.

8. The method of claim 1, further comprising:
presenting an entry presentation page in which a predetermined amount of object set entry recommendation information matching a current user type is presented, wherein the object set entry recommendation information is presented based on a target combination style corresponding to the current user type, and the target combination style is used to indicate a page presentation position and a size corresponding to each piece of the object set entry recommendation information; and
in response to a trigger operation for object set entry recommendation information in the entry presentation page, presenting an object recommendation page of the triggered object set entry recommendation information.

9. The method of claim 1, further comprising:
presenting an entry presentation page in which activity recommendation information is presented, the activity recommendation information comprising at least one activity entry and an activity set entry; and
in response to a trigger operation for the activity set entry, presenting an activity set content page corresponding to the activity set entry; or
in response to a trigger operation for the activity entry, presenting a target activity content page corresponding to the triggered activity entry.

10. The method of claim 1, further comprising:
in response to a first trigger operation on a region where first recommendation information is located, hiding the first recommendation information, and presenting set function entry recommendation information; or
in response to a second trigger operation on a region where the set function entry recommendation information is located, hiding the set function entry recommendation information, and presenting the first recommendation information;
wherein the first trigger operation is a sliding operation along a first direction on a region where the first recommendation information is located, the second trigger operation is a sliding operation along a second direction on a region where the set function entry recommendation information is located, and the first direction is opposite to the second direction; or
a set control is displayed in the region where the first recommendation information is located or the region where the set function entry recommendation information is located, and the first trigger operation or the second trigger operation is a trigger operation for the set control.

11. An electronic device, comprising:
one or more processors; and
a storage device, configured to store one or more programs;
wherein the one or more programs, when executed by the one or more processors, cause the one or more processors to perform acts comprising:
in response to a predetermined operation, presenting an object recommendation page, the object recommendation page comprising recommendation information respectively corresponding to a plurality of recommended objects, and the recommendation information comprising multimedia recommendation information of the recommended object; and
in response to detecting a trigger operation for the multimedia recommendation information of a recommended object, presenting a multimedia content page corresponding to the recommended object, the multimedia content page being used for playing multimedia recommendation information corresponding to the recommended object.

12. The electronic device of claim 11, wherein the recommendation information comprises an attribute region, an operation control region and a multimedia information region, the attribute region is used for presenting attribute information of the recommended object, the operation control region is used for presenting an entry control of an operation corresponding to the recommended object, and the multimedia information region is used for presenting the multimedia recommendation information.

13. The electronic device of claim 12, wherein the acts further comprise:
presenting an entry presentation page comprising a presentation mode switching entry; and
in response to a trigger operation for a presentation mode label in the entry presentation page, presenting an object recommendation page corresponding to the triggered presentation mode label; or
in response to a sliding operation on the entry presentation page and a track or an end position of the sliding operation meeting a set condition, determining a presentation mode currently displayed by the presentation mode switching entry as the target presentation mode, and presenting an object recommendation page corresponding to the target presentation mode.

14. The electronic device of claim 13, wherein the presentation mode switching entry displays an identifier of a presentation mode corresponding to a currently presented object recommendation page, and the method further comprises:
in response to a trigger operation for an identifier of the presentation mode currently displayed by the presentation mode switching entry, displaying identifiers of a plurality of presentation modes,
wherein a presentation order of the identifiers of the plurality of presentation modes is determined based on predetermined priorities.

15. The electronic device of claim 12, wherein the acts further comprise:
presenting an object recommendation page comprising a presentation mode switching entry, the presentation mode switching entry displaying an identifier of a presentation mode corresponding to a currently displayed object recommendation page;
in response to a trigger operation for the presentation mode switching entry, presenting identifiers of a plurality of presentation modes;
in response to a selection operation for an identifier of a target presentation mode from the identifiers of the plurality of presentation modes, presenting the object recommendation page corresponding to the target presentation mode.

16. The electronic device of claim 12, wherein in response to detecting the trigger operation for the multimedia recommendation information of the recommended object, presenting a multimedia content page corresponding to the recommended object comprises:
in response to detecting the trigger operation for the multimedia recommendation information of the recommended object, presenting a multimedia content page corresponding to the recommended object, and playing, in the multimedia content page, a video associated with the recommended object that is from the corresponding presentation mode.

17. The electronic device of claim 11, wherein the object recommendation page further comprises information to be recommended, regions where the information to be recommended and recommendation information of the recommended object are located are independent from each other, and data sources of the information to be recommended and recommendation information of the recommended object are independent from each other.

18. The electronic device of claim 11, wherein the acts further comprise:
presenting an entry presentation page in which a predetermined amount of object set entry recommendation information matching a current user type is presented, wherein the object set entry recommendation information is presented based on a target combination style corresponding to the current user type, and the target combination style is used to indicate a page presentation position and a size corresponding to each piece of the object set entry recommendation information; and
in response to a trigger operation for object set entry recommendation information in the entry presentation page, presenting an object recommendation page of the triggered object set entry recommendation information.

19. The electronic device of claim 11, wherein the acts further comprise:
presenting an entry presentation page in which activity recommendation information is presented, the activity recommendation information comprising at least one activity entry and an activity set entry; and
in response to a trigger operation for the activity set entry, presenting an activity set content page corresponding to the activity set entry; or
in response to a trigger operation for the activity entry, presenting a target activity content page corresponding to the triggered activity entry.

20. A non-transitory storage medium comprising computer-executable instructions that, when executed by a computer processor, cause the computer processor to perform acts comprising:
in response to a predetermined operation, presenting an object recommendation page, the object recommendation page comprising recommendation information respectively corresponding to a plurality of recommended objects, and the recommendation information comprising multimedia recommendation information of the recommended object; and
in response to detecting a trigger operation for the multimedia recommendation information of a recommended object, presenting a multimedia content page corresponding to the recommended object, the multimedia content page being used for playing multimedia recommendation information corresponding to the recommended object.
